(19) United States
(12) Patent Application Publication
(10) Pub. No.: US 2007/0037932 A1
(43) Pub. Date: Feb. 15, 2007

(54) Nucleating agent

(76) Inventors: Espen Ommundsen, Langesund (NO); Merete Skar, Stathelle (NO); Katrin Nord-Varhaug, Porsgrunn (NO)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/566,775

(22) PCT Filed: Aug. 3, 2004
(86) PCT No.: PCT/EP04/08689

§ 371 Date: Aug. 9, 2006

(30) Foreign Application Priority Data
Aug. 4, 2003 (GB) 0318257.3

(51) Int. Cl. C08L 23/04

(52) U.S. Cl. 525/240

(57) ABSTRACT

Use of a first polyethylene polymer having a density of at least 950 kg/m³ as a nucleating agent for a second polyethylene polymer having a density of less than 940 kg/m³.

### 1. FIELD OF THE INVENTION

This invention relates to a new nucleating agent for polyethylene, in particular to the use of high density polyethylene to nucleate lower density polyethylene.

### 2. DISCUSSION OF THE BACKGROUND ART

Traditionally, the use of nucleating agents with polyethylenes was not required. Polyethylenes were often produced using Ziegler-Natta catalysts which give rise to polyethylenes with relatively broad molecular weight distributions and broad comonomer distributions which normally did not require nucleation.

More recently, single site catalysts, e.g. metallocene catalysts, have been employed in the manufacture of polyethylene polymers and these catalysts tend to give polymers having very much narrower molecular weight distributions and comonomer distributions.

Hence, when crystallisation begins, almost all the polymer molecules are capable of crystallising at the same temperature causing a large heat of crystallisation and a reduced cooling rate. The result of this is the formation of large spherulites or other crystal domains which cause increased haze and a corresponding lack of transparency. This is a particular problem for film technology where transparency is vital.

To overcome this problem, nucleating agents have been added to polymer melts. Nucleating agents are chemical substances which when incorporated into a polymer form nuclei for the growth of crystals in the polymer melt. In polypropylene, for example, a higher degree of crystallinity and more uniform crystalline structure is obtained by adding nucleating agents such as adipic and benzoic acid or certain of their metal salts.

Nucleating agents are designed to improve crystallisation behaviour in processing, i.e. cycle time or line speed, as well as crystallinity and morphology in the final product thereby improving optical and mechanical properties.

Thus, it is known to add nucleating agents such as aluminium salts or sodium salts of aromatic carboxylic acids, e.g. sodium benzoate to a polymer melt to increase transparency and reduce haze.

In EP-A-206515, vinylcycloalkane is suggested as a nucleating agent for polypropylene. In JP 58149942, a higher melting point polybutylene terephthalate has been used as a nucleating agent for a lower melting point polybutylene terephthalate without impairing its physical properties or heat cycle resistance. In U.S. Pat. No. 5,082,902 crystallisation half times and mold cycle time of high density polyethylene are reduced and impact energy improved by blending two linear ethylene polymers differing in density by 0.015 to 0.150 g/cm³.

It has now been surprisingly found that low density polyethylene polymers, e.g. polymers such as linear low density polyethylene (LLDPE), copolymers or terpolymers of ethylene can be nucleated by using other, preferably higher density polyethylenes. Surprisingly, this has been found to result in a reduction in haze and an increase in gloss.

### SUMMARY OF THE INVENTION

Hence, viewed from one aspect the invention provides the use of a polyethylene polymer, preferably a polyethylene homopolymer, having a density of at least 950 kg/m³ as a nucleating agent for a polyethylene polymer having a density of less than 940 kg/m³, said polymer being, for example, a copolymer or terpolymer of ethylene with at least one C₃₋₁₀ α-olefin.

In a first aspect of the invention, the polymer to which the nucleating agent is to be added (the base polymer) is preferably an ethylene copolymer with a C₃₋₁₀ α-olefin, e.g. propylene, butene, hexene or octene (especially an ethylene/butene or ethylene/hexene copolymer) or an ethylene terpolymer with at least two C₃₋₁₀ α-olefins, preferably selected from propylene, butene, hexene or octene (especially an ethylene/butene/hexene terpolymer). The polymer to which the nucleating agent is being added should have a density of less than 940 kg/m³, preferably have a density of less than 935 kg/m³, more preferably less than 927 kg/m³, especially less than 920 kg/m³.

The amount of comonomer present in the polymer may vary but is preferably in the range 0.5 to 15% wt, e.g. 2 to 10% wt.

### DETAILED DESCRIPTION OF THE PREFERRED EMBODIMENT

The polymer to which the nucleating agent is added should preferably be multimodal (e.g. bimodal), i.e. its molecular weight profile does not comprise a single peak but instead comprises the combination of two or more peaks (which may or may not be distinguishable) centred about different average molecular weights as a result of the fact that the polymer comprises two or more separately produced components.

The polymer is preferably manufactured using single site catalyst technology as is well known in the art. Thus, for example, bimodal ethylene polymers may be prepared by two or more stage polymerization or by the use of two or more different polymerization catalysts in a one stage polymerization. Preferably however they are produced in a two-stage polymerization using the same catalyst, e.g. a metallocene catalyst, in particular a slurry polymerization in a loop reactor followed by a gas phase polymerization in a gas phase reactor. A loop reactor—gas phase reactor system is marketed by Borealis A/S, Denmark as a BORSTAR reactor system.

The single site catalyst is preferably a catalyst comprising a metal coordinated by one or more η-bonding ligands. Such η-bonded metals are normally referred to as metallocenes and the metals are typically Zr, Hf or Ti, especially Zr or Hf. The η-bonding ligand is typically an η⁵-cyclic ligand, i.e. a homo or heterocyclic cyclopentadienyl group optionally with fused or pendant substituents. Such metallocene catalysts have been widely described in the scientific and patent literature for about twenty years. Such metallocene catalysts are frequently used with catalyst activators or co-catalysts, e.g. alumoxanes such as methylaluminoxane, again as widely described in the literature. A preferred catalysts include bis(n-butylcyclopentadienyl) hafnium dibenzyl or rac-ethylene-bis(2-tertbutyldimethylsiloxyindenyl) zirconium dichloride.

The MFR₂ of the polymer to which the nucleating agent is added is generally low, e.g. in the range 0.1 to 10, e.g. 0.5 to 5 g/10 min. Its molecular weight distribution (MWD) is preferably 2.5 to 10, especially 3.0 to 8.0. The weight average molecular weight (Mw) of the polymer is preferably between 50,000 and 250,000 g/mol.

The polymer acting as the nucleating agent is a high density polyethylene, preferably an ethylene homopolymer. The nucleating polymer may be prepared using Ziegler-Natta catalysis or single site catalysis.

The expression “homopolymer” of ethylene used herein refers to a polyethylene that consists substantially, i.e. at least 98% by weight, preferably at least 99% by weight, more preferably at least 99.5% by weight, most preferably at least 99.8% by weight, of ethylene.

The nucleating polymer should have an MFR₂ in the range 0.1 to 1000, preferably 1 to 100, especially 5 to 20. Its density should exceed 950 kg/m³, more preferably 955 kg/m³, especially 960 kg/m³.

Thus, it is preferred if the difference in density between the first and second polymers is at least 15 kg/m³, e.g. at least 20 kg/m³, more preferably at least 30 kg/m³, especially at least 40 kg/m³.

It is surprising that the incorporation of a higher density and hence higher crystallinity polyethylene to a lower crystallinity polymer can still give rise to less hazy material. Higher crystallinity polymer tends to be associated with more haze however, in the present invention the total haze of the polymer mixture is less than what would be expected by partial summation.

Conveniently, the polymer to be used as the nucleating agent is unimodal and is made in a slurry or gas phase polymerisation. Its MWD should be between 2 and 20, preferably 2 to 10, with an MW of approximately 20,000 to 500,000 D, e.g. 50,000 to 200,000 D.

The polymer is preferably manufactured using a single site or Ziegler-Natta catalyst which are well-known and are widely described in the literature. Their use is commonplace to the skilled polymer chemist. Single site technology is preferably employed.

The amount of nucleating agent required in the invention may vary but is preferably between 0.2 to 30% by weight, more preferably between 0.4 to 15% by weight, especially 0.6 to 5% wt, e.g. less than 2% wt relative to the total amount of polyethylene base polymer present.

The nucleating agent and polymer may be mixed in any convenient fashion, e.g. compounding, blending, coextrusion etc, although dry blending is preferred. Alternatively, the nucleating polymer may be prepared in a polymerisation stage prior to a polymerisation stage where the base polymer is formed. The nucleating polymer could also be made simultaneously with the base polymer.

The combination of a higher density polyethylene polymer with a lower density polyethylene forms a further aspect of the invention. Hence, viewed from a further aspect the invention provides a polymer composition comprising:
A) less than 5% wt (e.g 0.5. to 5% wt) of a polyethylene homopolymer having a density of at least 950 kg/m³; and
B) at least 95% wt of a polyethylene co- or terpolymer with at least one C₃₋₁₀ α-olefin made by single site catalysis, said polymer having a density of less than 940 kg/m³.

The resulting polymer mixture may be used in injection moulding, blow moulding, extrusion coating etc but is of particular value in film technology. The use of the nucleating agent reduces haze and increases gloss giving rise to improved transparency. Transparent films are of particular use in the medical and food industries were avoiding the use of other nucleating agents is advantageous since such agents may not be licensed for food contact.

Viewed from another aspect therefore the invention provides a film comprising a polymer composition as hereinbefore described.

Where films are to be used for packaging certain products, in particular foodstuffs, it is especially important that the film has high clarity and gloss. Where films are made only of SSC polymers (i.e. polymers produced using single site catalysts), they often are relatively hazy and/or matt in appearance. This can be addressed by blending in with the SSC polyethylene an LDPE, e.g. such that up to 8% wt, more preferably 2 to 7% wt, especially about 5% wt, particularly about 3.5% wt of the polymer blend is the LDPE. LDPE of relatively high density, e.g. 925 to 932 kg/m³, is particularly effective in this regard. An example of such an LDPE is available commercially from Borealis A/S under the trade name Himod LDPE which is produced by tubular high pressure processes.

This effect of the relatively high density LDPE on optical properties of PE film is quite unexpected as it would have been expected that the higher the density of the LDPE additive the less the improvement in optical properties would be. Accordingly, an aspect of the invention provides the use of a relatively high density LDPE, e.g. having a density of 925 to 932 kg/m³, as an additive in a polyethylene composition of the invention (e.g. as 1 to 5% wt of the composition) for film production to improve the optical characteristics of the film produced therefrom.

Films may be prepared using conventional film production techniques. The film will typically be 10 to 300 μm in thickness, especially 15 to 100 μm. The specific thickness will be selected according to the nature of the product to be packaged by the film and its expected subsequent handling conditions.

The films however are preferably extruded, particularly preferably with a blow up ratio of 2:1 to 4:1. If desired, the film may be multilayered, e.g. as a result of lamination or coextrusion.

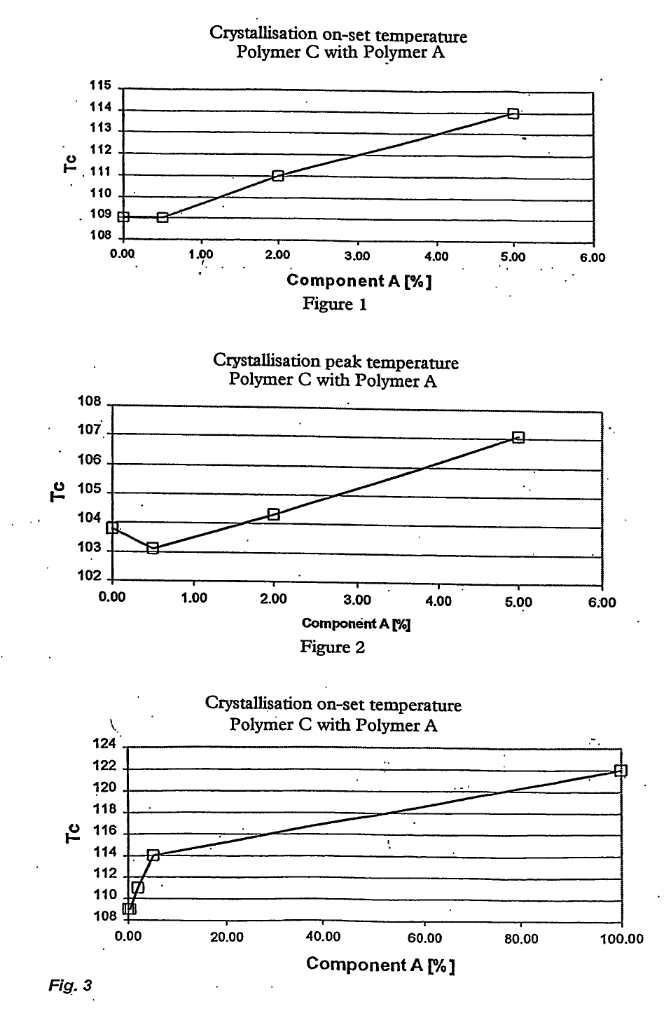

The invention will now be described with reference to the following non-limiting examples and FIGS. 1 to 3 which show crystallisation on-set temperatures for the mixtures in Example 2.

### EXPERIMENTAL

MFR:

MFR was measured according to ISO 1133 at 190° C. The load has been indicated as a subscript, i.e. MFR₂ denotes the measurement has been carried out under a load of 2.16 kg and MFR₂₁ denotes the measurement has been carried out under a load of 21.6 kg, respectively.

MWD:

The weight-average molecular weight M_{w}, and the molecular weight distribution (MWD=M_{w}/Mₙ, where Mₙ equals number-average molecular weight) is measured by a method based on ISO/TC61/SC5 N 5024. The main difference between this method and the method used is the temperature; the ISO method being at room temperature while the method used being at 140EC. The ratio of M_{w} and Mₙ is a measure of the broadness of the distribution, since each is influenced by the opposite end of the “population”.

Density:

Density is measured according to ISO 1183/D.

Polymer Preparation:

Polymer A is Component A prepared according to Example 1 of WO02/070602. Polymer A is an ethylene homopolymer made using bis(n-butyl-Cp)ZrCl₂ and MAO having a density of 957 kg/m³, Mw of 77,000 D, and MWD of 2.7.

The polyethylene base polymers B and C were prepared in a bimodal two stage reactor under the following conditions: The catalyst used for polymer B was bis(n-butylcyclopentadienyl) hafnium dibenzyl and for polymer C was rac-ethylene-bis(2-tertbutyldimethylsiloxyindenyl) zirconium dichloride.

| Loop | Polymer B | Polymer C |
|---|---|---|
| Comonomer | C4 | C4 |
| MFR2 | 100 | 119 |
| density | 937 | 937 |
| Temp. | 85 | 85 |
| Pressure (Bar) | 60 | 60 |
| H2/C2 (mol/kmol) | 0.33 | 0.55 |
| C4/C2 | 139 | 182 |
| [C2] mol % | 6.6 | |

| GPR | Polymer B | Polymer C |
|---|---|---|
| Comonomer | C6 | C4 |
| Temp | 80 | 75 |
| C2 mol % | 25 | 52 |
| C6/C2 mol/kmol | 14 | — |
| C4/C2 mol/kmol | — | 68 |
| H2/C2 mol/kmol | 0.35 | 0 |
| Split | 50/50 | 49/51 |

Polymer B has an Mw of 136,000 D, an MWD of 5.4, and comonomer contents 1.9 wt % C4 and 6.4 wt % C6 (C13 NMR). Polymer C has an Mw of 113,000 D, an MWD of 4.4, and comonomer content 6.2 wt % C4 (FTIR).

MG9647A is a commercially available polymer grade from Borealis A/S. (MWD 3.3, Mw 80,000)

### EXAMPLE 1

### Polymers Used in Blending Trials

| Material | | MFR2 | d |
|---|---|---|---|
| Polymer B | Bimodal SSC terpolymer | 1.3 | 918 |
| MG9647A | Unimodal Z-N polymer from | 8.0 | 964 |
| | Gas Phase reactor | | |

Polymers were dry blended (not compounded) and 40 μm films were produced on an ANKUTEC film line (50 mm die diameter, die gap: 2.1 mm), BUR: 2.5 , Temp.: 210° C.)

Haze and Gloss of the produced film were measured according to ASTM D 1003 and ASTM D 523-66T.

| | Haze (%) | Gloss |
|---|---|---|
| Pure Polymer B | 48.6 | 23.8 |
| Poly B + 0.5% MG9647A | 35.2 | 38.5 |
| Poly B + 1% MG9647A | 38.8 | 48.9 |
| Poly B + 3% MG9647A | 31.0 | 68.3 |

Conclusion: Significant improvement in optical properties by blending small amounts of Z-N HDPE.

### EXAMPLE 2

| Material | | MFR2 | density |
|---|---|---|---|
| Polymer C | Bimodal LLD | 1.5 | 920 |
| Polymer A | Homopolymer | 6.5 | 958 |

Materials were compounded at 200EC in A Midi 2000 machine. Compounding time was 3 minutes. Respectively, 0.5, 2 and 5% of A was blended into polymer C. The extrudate was then used to press films of thickness approximately 180 μm in a hot stage.

DSC Analysis

Samples of equal size were cut from pressed films, sample mass around 5 mg. Heating and cooling rates were 10 K/min. Melting peaks of Polymer C and Component A were 115.9 and 131.7EC respectively. FIGS. 1 to 3 show variations of crystallisation onset and peak temperatures as a function of the percentage of A in the blend.

The figures reflect a nucleation effect.

What is claimed is:

1. A method of nucleating a second polyethylene polymer comprising:
nucleating said second polyethylene polymer having a density of less than 940 kg/m³ with a nucleating agent, wherein said nucleating agent is a first polyethylene polymer having a density of at least 950 kg/m³.

2. The method according to claim 1, wherein said first polyethylene polymer is a homopolymer.

3. The method according to claim 1, wherein the density of the first polyethylene polymer is at least 955 kg/m³.

4. The method according to claim 1, wherein the MFR₂ of the first polyethylene polymer is 5 to 20 g/10 min.

5. The method according to claim 1, wherein the amount of first polyethylene polymer employed is between about 0.6 to 5% wt, relative to the weight of second polyethylene polymer.

6. The method according to claim 1, wherein said second polyethylene polymer is a copolymer or terpolymer of ethylene with at least one C₃₋₁₀ α-olefin.

7. The method according to claim 1, wherein said second polyethylene polymer is made using a single site catalyst.

8. The method according to claim 1, wherein said second polyethylene polymer is an ethylene/hexene copolymer or ethylene/butene/hexene terpolymer.

9. The method according to claim 1, wherein the density of the second polyethylene polymer is less than 935 kg/m³.

10. A polymer composition comprising:
A) 0.5 to 5% wt of a polyethylene homopolymer having a density of at least 950 kg/m³; and
B) at least 95% wt of a polyethylene co- or terpolymer with at least one C₃₋₁₀ α-olefin, said polymer having a density of less than 940 kg/m³.

11. A film comprising a polymer composition comprising:
A) 0.5 to 5% wt of a polyethylene homopolymer having a density of at least 950 kg/m³; and
B) at least 95% wt of a polyethylene co- or terpolymer with at least one C₃₋₁₀ α-olefin, said polymer having a density of less than 940 kg/m³.

12. The film as claimed in claim 11 having a Haze (ASTM D 1003) of less than 40% and a gloss (ASTM D 523-66T) of at least 35.
